(19) United States
(12) Patent Application Publication
(10) Pub. No.: US 2012/0219636 A1
(43) Pub. Date: Aug. 30, 2012

(54) ENHANCED REMOVAL OF VIRUSES FROM FRESH PRODUCE

(75) Inventors: Jianrong Li, Dublin, OH (US); Ashley Predmore, Columbus, OH (US)

(73) Assignee: THE OHIO STATE UNIVERSITY, Columbus, OH (US)

(21) Appl. No.: 13/406,689

(22) Filed: Feb. 28, 2012

Related U.S. Application Data
(60) Provisional application No. 61/447,402, filed on Feb. 28, 2011.

(51) Int. Cl. A01N 59/00; A01P 1/00; A01N 43/08; A01N 31/14; A01N 33/12; A01N 37/02; A01N 41/02

(52) U.S. Cl. 424/616; 424/665; 514/557; 514/517; 514/718; 514/642; 514/473

(57) ABSTRACT

A formulation and method for removing viruses from fresh produce, including at least one surfactant, and a solvent. Preferably, the formulation also includes at least one sanitizer.

### BACKGROUND OF THE INVENTION

This invention relates generally to the field of removing and/or reducing pathogens, such as viruses and/or bacteria, more specifically to removing foodborne viruses from fresh produce.

Produce is a generalized term for a group of farm-produced goods, not limited to fruits and vegetables (i.e. meats, grains, oats, etc.). More specifically, the term “produce” often implies that the products are fresh and generally in the same state as where they were harvested. Such fresh produce usually are minimally processed in order to preserve their freshness, taste, look and longevity in the market. Further, they are easily contaminated with any foodborne pathogen at pre-and post-harvest stages, such as irrigation or wash water, fertilizers of animal waste and municipal biosolids, infected operators, and operation of facilities with poor sanitation.

A pathogen or infectious agent is a microbe or microorganism, such as a virus, bacterium, prion, or fungus that causes disease in its human, animal or plant host. According to a recent compilation of US outbreak data from 1998 to 2005, fresh produce has become dominant as a vehicle in foodborne virus outbreaks. Disease surveillance shows that norovirus is the top causative agent for fresh produce outbreaks (40%), followed by Salmonella (18%), Escherichia coli 0157:H7 (8%), Clostridium (6%) and hepatitis A virus (4%). Fresh produce related outbreaks of norovirus have been reported in lettuce, salad, fruit salad, tomatoes, carrots, melons, strawberries, raspberries, orange juice, fresh cut fruits, spring onions and other fresh produce.

Human norovirus is a major enteric foodborne virus that is an incredibly large problem in foods due to its small infectious dose (<10 particles) and its high stability in the environment. It is estimated that at least 90% of acute non-bacterial gastroenteritis outbreaks can be attributed to norovirus, but this number may even be underestimated due to the large number of asymptomatic infections and lack of methods for rapid detection of the viral infection. According to a recent report from the Center for Disease Control and Prevention, approximately 48 million people suffer from norovirus-induced gastroenteritis each year in the US: 128,000 people are hospitalized, and 3,000 people die from norovirus each year. Outbreaks of human norovirus are common where people are in close contact such as cruise ships, restaurants, hotels, schools, the military, nursing homes, and hospitals. Transmission of norovirus is primarily by the fecal-oral route, either by person to person spread or ingesting contaminated food or water. The primary symptoms of norovirus include diarrhea, vomiting, fever, chills, and extreme dehydration. It has been a challenge to work with human norovirus since it does not propagate in cell culture and there is no suitable animal model for the virus. For this reason, studies of human norovirus must rely on proper surrogates such as murine norovirus 1 (MNV-1) or feline calicivirus (FCV). Because of these challenges, human norovirus and other Caliciviruses are classified as category B priority bio-defense agents according to the National Institute of Allergy and Infectious Diseases (NIAID).

With an increasing number of people striving to eat healthier by increasing their consumption of fresh fruits and vegetables, the contamination of fresh produce has become a major health concern. Further, while numerous studies have been reported on managing and/or reducing bacterial contamination of fresh produce, knowledge about reducing viral contamination of fresh produce remains limited.

In the current industry, fresh produce usually undergoes a brief sanitization step after harvest from the field. Unfortunately, the current commonly used sanitizers are not effective in removing viral contaminants from fresh produce. The most commonly used sanitizer, a 200 ppm chlorine solution, typically gives less than 1.2 logs of virus reduction on fresh produce.

Recently, Baert et al. (The efficacy of preservation methods to inactivate foodborne viruses. Int. J. Food Microbiol. 131:83-94, 2009) found that tap water washing only gave an average of 0.94 logs of reduction on shredded lettuce, while the addition of 200 ppm of sodium hypochlorite only led to an additional 0.48 logs of virus reduction, and the addition of 80 ppm of peroxyacetic acid brought about only 0.77 additional logs of reduction.

### BRIEF SUMMARY OF THE INVENTION

Therefore, there is an urgent need to develop a more effective sanitizer to remove pathogens, such as noroviruses, from fresh produce. The present invention is a simple, inexpensive sanitizing formulation to enhance removal of pathogens from fresh produce to greater than 3-logs pathogen reduction, which includes at least one suitable surfactant and a solvent. Preferably, the formulation includes at least one suitable surfactant, at least one sanitizer, and a solvent. Further, the formulation can include at least one fresh produce.

Suitable surfactants can be anionic surfactants, non-ionic surfactants, cationic surfactants, zwitterionic surfactants, and a mixture thereof. The suitable solvent is water, or other similar aqueous solvents. Preferably, the formulation also includes at least one sanitizer, which is selected from a group comprising chlorine, hydrogen peroxide, quaternary ammonium compounds, organic acids, organic salts, organic bases, and a mixture thereof.

The present invention also includes a method of reducing viruses on produce, including adding at least one surfactant to the sanitization process of the produce, in which at least one sanitizer is used. Alternatively, the method of reducing viruses on produce includes adding a formulation of at least one surfactant, at least one sanitizer, and one solvent to the sanitization process of the produce.

### BRIEF DESCRIPTION OF THE SEVERAL VIEWS OF THE DRAWINGS

FIG. 1 is a diagram of viral titer (log 10 PFU/ml) versus various types of sanitizers, control (untreated), tap water, chlorine water, 1 ppm to 1000 ppm SDS, illustrating the effect of various SDS concentrations on removal of MNV-1 from strawberries in Example 1. Data are the means of three replicates. Error bars represent ±1 standard deviations.

FIG. 2 is a diagram of viral titer (log 10 PFU/ml) versus various types of sanitizers, control (untreated), tap water, chlorine water, and a combination of 1 ppm to 1000 ppm SDS and 200 ppm chlorine solution, illustrating enhanced removal of MNV-1 from strawberries by combination of SDS and chlorine solution in Example 1. Data are the means of three replicates. Error bars represent ±1 standard deviations.

FIG. 3 is a diagram of viral titer (log 10 PFU/ml) versus various types of sanitizers, control (untreated), tap water, chlorine water, 50 ppm SDS, and a combination of 50 ppm SDS and 200 ppm chlorine solution for lettuce, cabbage, and raspberries, illustrating enhanced removal of MNV-1 from lettuce, cabbage, and raspberries by SDS solution or by combination of SDS with chlorine solution in Example 1. Data are the means of three replicates. Error bars represent ±1 standard deviations.

FIG. 4 is a diagram of viral titer (log 10 PFU/ml) versus various types of sanitizers, control (untreated), tap water, chlorine water, 50 ppm NP 40, and a combination of 50 ppm NP 40 and 200 ppm chlorine solution for strawberry, lettuce, cabbage, and raspberries, illustrating enhanced removal of MNV-1 from four types of fresh produce by NP 40 in Example 1. Data are the means of three replicates. Error bars represent ±1 standard deviations.

FIG. 5 is a diagram of viral titer (log 10 PFU/ml) versus various types of sanitizers, control (untreated), tap water, chlorine water, 50 ppm Triton X-100, and a combination of 50 ppm Triton X-100 and 200 ppm chlorine solution for strawberries, lettuce, cabbage, and raspberries, illustrating enhanced removal of MNV-1 from four types of fresh produce by Triton X-100 in Example 1. Data are the means of three replicates. Error bars represent ±1 standard deviations.

FIG. 6 is a diagram of viral titer (log 10 PFU/ml) versus various types of sanitizers, control (untreated), tap water, chlorine water, 50 ppm Tween 20, and a combination of 50 ppm Tween 20 and 200 ppm chlorine solution for strawberries, lettuce, cabbage, and raspberry, illustrating enhanced removal of MNV-1 from four types of fresh produce by Tween 20 in Example 1. Data are the means of three replicates. Error bars represent ±1 standard deviations.

FIG. 7 is a diagram of viral titer (log 10 PFU/ml) versus incubation time (hours) for 50 ppm to 10,000 ppm SDS, NP 40, Triton X-100, and Tween 20, illustrating inactivation of MNV-1 by various surfactants in Example 2. Data are the means of three replicates. (A) 50 ppm; (B) 200 ppm; (C) 1,000 ppm; and (D) 10,000 ppm.

FIG. 8 is a diagram of viral titer (log 10 PFU/ml) versus incubation time (hours) for 50 ppm to 10,000 ppm SDS, NP 40, Triton X-100, and Tween 20, illustrating inactivation of VSV by surfactants in Example 2. Data are the means of three replicates.

FIG. 9 includes electron microscopic pictures illustrating SDS damaged virus particles as shown in Example 3. Purified MNV-1 and VSV were incubated with 10,000 ppm of SDS at 37° C. for 72 hours, respectively. Complete virus inactivation was confirmed by plaque assay. (A) untreated MNV-1; (B) MNV-1 treated by SDS; (C) Untreated VSV; (D) VSV treated by SDS.

FIG. 10 is a flow diagram illustrating a typical practice for processing leafy greens in the fresh produce industry.

FIG. 10A is a flow diagram illustrating potential applications of a surfactant (SDS or a combination of SDS-chlorine) to remove viruses from fresh produce during the current practice of processing leafy greens. The square boxes show the supply chain flow for leafy greens in the fresh produce industry. Proposed interventions by the surfactant to minimize the virus contamination are shown as ovals.

FIG. 11 is a diagram of viral titer (log 10 PFU/ml) versus various types of sanitizers, illustrating enhanced removal of MNV-1 norovirus surrogate from lettuce by combinations of SDS and each sanitizer in Example 4. Surfactant-sanitizer combinations evaluated were SDS-leulinic acid, SDS-chlorine water, SDS-quaternary ammonium, SDS-acetic acid, SDS-hydrogen peroxide, and SDS-peracetic acid. The viral titer results by using these surfactant-sanitizer combinations were compared to each sanitizer alone, tap water, and untreated samples.

FIG. 12 is a diagram of viral titer (log 10 PFU/ml) versus various types of sanitizers, illustrating enhanced removal of MNV-1 norovirus surrogate from strawberries by combinations of SDS and each sanitizer in Example 4. Surfactant-sanitizer combinations evaluated were SDS-levulinic acid, SDS-chlorine water, SDS-quaternary ammonium, SDS-acetic acid, SDS-hydrogen peroxide, and SDS-peracetic acid. The viral titer results from using these surfactant-sanitizer combinations were compared to each sanitizer alone, tap water, and untreated samples.

FIG. 13 is a diagram of viral titer (log 10 PFU/ml) versus various types of sanitizers, illustrating enhanced removal of MNV-1 norovirus surrogate from spinach by combinations of SDS and each sanitizer in Example 4. Surfactant-sanitizer combinations evaluated were SDS-levulinic acid, SDS-chlorine water, SDS-quaternary ammonium, SDS-acetic acid, SDS-hydrogen peroxide, and SDS-peracetic acid. The viral titer results from using these surfactant-sanitizer combinations were compared to each sanitizer alone, tap water, and untreated samples.

FIG. 14 is a diagram of viral titer (log 10 PFU/ml) versus various types of sanitizers, illustrating enhanced removal of human rotavirus from lettuce by combinations of SDS and each sanitizer in Example 5. Surfactant-sanitizer combinations evaluated were SDS-levulinic acid, SDS-chlorine water, SDS-quaternary ammonium, SDS-acetic acid, SDS-hydrogen peroxide, and SDS-peracetic acid. The viral titer results from using these surfactant-sanitizer combinations were compared to chlorine water only, tap water, and untreated samples.

FIG. 15 is a diagram of viral titer (logs 10 PFU/ml) versus various types of sanitizers, illustrating enhanced removal of human rotavirus from strawberries by combinations of SDS and each sanitizer in Example 5. Surfactant-sanitizer combinations evaluated were SDS-levulinic acid, SDS-chlorine water, SDS-quaternary ammonium, SDS-acetic acid, SDS-hydrogen peroxide, and SDS-peracetic acid. The viral titer results from using these surfactant-sanitizer combinations were compared to chlorine water only, tap water, and untreated samples.

FIG. 16 is a diagram of viral titer (log 10 PFU/ml) versus various types of sanitizers, illustrating enhanced removal of human rotavirus from spinach by combinations of SDS and each sanitizer in Example 5. Surfactant-sanitizer combinations evaluated were SDS-levulinic acid, SDS-chlorine water, SDS-quaternary ammonium, SDS-acetic acid, SDS-hydrogen peroxide, and SDS-peracetic acid. The viral titer results by using these surfactant-sanitizer combinations were compared to chlorine water only, tap water, and untreated samples.

FIG. 17 is a diagram of viral titer (log 10TCID₅₀/ml) versus various types of sanitizers, illustrating enhanced removal of hepatitis A virus from lettuce by combinations of SDS and each sanitizer in Example 6. Surfactant-sanitizer combinations evaluated were SDS-levulinic acid, SDS-chlorine water, SDS-quaternary ammonium, SDS-acetic acid, SDS-hydrogen peroxide, and SDS-peracetic acid. The viral titer results from using these surfactant-sanitizer combinations were compared to chlorine water only, tap water, and untreated samples.

FIG. 18 is a diagram of viral titer (log 10 TCID₅₀/ml) versus various types of sanitizers, illustrating enhanced removal of hepatitis A virus from strawberries by combinations of SDS and each sanitizer in Example 6. Surfactant-sanitizer combinations evaluated were SDS-levulinic acid, SDS-chlorine water, SDS-quaternary ammonium, SDS-acetic acid, SDS-hydrogen peroxide, and SDS-peracetic acid. The viral titer results from using these surfactant-sanitizer combinations were compared to chlorine water only, tap water, and untreated samples.

FIG. 19 is a diagram of viral titer (log 10 TCID₅₀/ml) versus various types of sanitizers, illustrating enhanced removal of hepatitis A virus from spinach by combinations of SDS and each sanitizer in Example 6. Surfactant-sanitizer combinations evaluated were SDS-levulinic acid, SDS-chlorine water, SDS-quaternary ammonium, SDS-acetic acid, SDS-hydrogen peroxide, and SDS-peracetic acid. The viral titer results from using these surfactant-sanitizer combinations were compared to chlorine water only, tap water, and untreated samples.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

Broadly, the present invention is a formulation suitable for effectively removing pathogens from fresh produce, which includes at least one suitable surfactant and a solvent. Preferably, the formulation further includes at least one sanitizer.

The preferred embodiment of the present invention is a formulation for removing foodborne viruses from fresh produce, including at least one suitable surfactant, at least one sanitizer, and a suitable solvent. The effective reduction of pathogens on fresh produce refers to about 3 logs reduction of pathogens or higher. About 3 logs of virus or pathogen reduction refer to any virus or pathogen reduction in the range of about 2.6 logs to about 3.4 logs of reduction. The effective reduction of pathogens or viruses can also be called “effective sanitization.” For purposes of the present invention, the term “produce” means that the produce are fresh and generally in the same state as when they were harvested. More specifically, the produce refers to fresh vegetables and/or fresh fruits, such as lettuce, cabbage, raspberries, and strawberries. Such fresh vegetables and/or fresh fruits are usually minimally processed in order to preserve their freshness, taste, look and longevity in the market. The term “produce” can be used interchangeably with the term “fresh produce.” The suitable solvent is water, or other similar aqueous solvents, such as electrolyzed water.

Suitable surfactants can be anionic surfactants, non-ionic surfactants, cationic surfactants, zwitterionic surfactants, and mixtures thereof. Suitable examples of the surfactants include sodium dodecyl sulfate (SDS)—an anionic surfactant, polysorbates (such as Tween 20, Tween 50 and Tween 80)—non-ionic surfactants, Triton X-100 (C₁₄H₂₂O(C₂H₄O)ₙ—a non-ionic surfactant, and NP-40—a non-ionic surfactant. As it would be used on fresh produce for human consumption, the suitable surfactant is generally recognized as safe by the general population. For example, Triton X-100 and NP-40 are widely used non-ionic surfactants, such as in mild detergents, which are generally considered safe for ingestion in small amounts. Preferred surfactants are SDS and polysorbates, which are considered GRAS (generally recognized as safe) substances by the Food and Drug Administration (FDA), with SDS being the most preferred because it is an FDA approved additive (FDA 21 CFR 172.822). Other FDA approved similar surfactant additives can also be used.

Among these surfactants, SDS appears in many daily used products such as dish soaps, toothpastes, and shampoos, and is an FDA approved food additive (FDA, 21 CFR 172.822). Shampoos and soaps contain dodecyl sulfate derivatives (sodium or ammonium dodecyl sulfate) at concentrations exceeding 10%. Toothpaste has very high concentrations (5 to 8%) of SDS and its derivatives. In foods, SDS is approved for use at concentrations of 25 to 1,000 ppm, depending on the type of products (FDA, 21 CFR 172.822).

Polysorbates similar in structure to Tween 20 have either GRAS status or are FDA approved food additives as well (FDA, 21 CFR 172.840, 172.836, and 172.838). For example, Tween 80 has been used as an emulsifier in ice cream and custard products, as a dispersing agent in pickle products and gelatin products, as an emulsifier in shortenings and whipped toppings, and as a defoaming agent in the production of cottage cheese (FDA 21 CFR 172.840). Tween 80 is typically used at levels not exceeding 0.1% of the finished product (FDA, 21 CFR 172.840). Even though Triton X-100 and NP-40 are not currently FDA approved, they are similar in function to SDS and Tween 20. Hence, they may be feasible alternatives in the future once more research is conducted on their safety.

The suitable sanitizer is selected from a group comprising chlorine, hydrogen peroxide, quaternary ammonium compounds, organic acids, organic salts, organic bases, and a mixture or mixtures thereof. Preferably, the suitable organic acids are levulinic acid, acetic acid, peracetic acid, citric acid, other similar organic acids, and a mixture or combinations thereof. Currently, the typical washing solution used in the food industry, sodium hypochlorite (the key ingredient of the chlorine bleach), usually gives less than 1 log of virus reduction. An effective virus removal from fresh produce requires about 3 logs of virus reduction or higher.

It has been a challenge to remove pathogens, such as viruses and bacteria, from fresh produce, and this is especially so with foodborne viruses. Foodborne viruses, such as human noroviruses, human rotaviruses, hepatitis A viruses, are typically non-enveloped RNA viruses. Based on the presence or absence of an envelope, viruses can be classified into enveloped or non-enveloped viruses. The envelopes typically are derived from the host cell membranes (lipid and proteins), and sometimes include viral glycoproteins. The lack of an envelope for foodborne viruses makes them very resistant to agents such as acids, pH, environmental stresses, and disinfectants. The typical washing solution used in the food industry, sodium hypochlorite, usually gives less than 1 log of virus reduction, which falls below the desired effective level of about 3 logs of virus reduction or higher. The formulation of the present invention is very effective in removing viruses from fresh produce, achieving about 3 logs of virus reduction or higher. At the same time, the present invention is capable of removing foodborne bacteria from fresh produce. The bacteria that the present invention is capable of sanitizing from fresh produce may include Escherichia coli O157: H7, Salmonella, Campylobacter jejuni, Campylobacter jejuni, Clostridium botulinum, Listeria monocytogenes, Streptococcus, Listeria monocytogenes, Shigella, Staphylococcus aureus, and other similar bacteria.

Surfactants are surface-active compounds that reduce the surface tension of a liquid. The addition of surfactants in a washing procedure makes the liquid spread more easily and lowers the interfacial tension between the two liquids, or between a liquid and a solid. In addition, they may act as detergents, wetting agents, emulsifiers, foaming agents, and dispersants. Surfactants contain both a hydrophilic and hydrophobic group, which allow them to alter the surface properties of the water and air or water and solid interface. Because of these properties, it is currently theorized that the surfactants may enable the release of tightly bound contaminants such as foodborne viruses from the surface of the produce.

More importantly, the mixtures of the surfactant and the sanitizer in water, such as 50 ppm SDS and 200 ppm chlorine solution, were able to show approximately 3 logs of virus reduction on all the tested fresh produce (see the examples). That is, the combination of at least one surfactant with at least one commonly used sanitizer was shown to be able to enhance the efficiency in removing viruses (pathogens) from fresh produce by approximately 100 times, achieving an effective level of about 3 logs of virus reduction or higher. It is possible that the surface tension reducing quality of the surfactants enables the commonly used sanitizer to reach much more surface area of the produce.

The combination of a suitable surfactant and a sanitizer is a very effective way of removing viruses to about 3 logs of virus removal from fresh produce. SDS is generally more effective in virus reduction, followed by NP40, Triton X-100, and Tween 20. The experimental results (Examples 2 and 3) demonstrate that these surfactants are able to cause significant damage to viral structures of both enveloped and non-enveloped viruses. Hence, the combination of surfactant and sanitizer of the present invention can be used to reduce or eliminate pathogens (such as viruses and bacteria) from fresh produce. It can also be used to eliminate pathogens in the environment and on other types of food. Further, the present invention can be used to remove pathogens from any surface area.

Preferably, the concentration of the surfactant in the formulation of the present invention is in the range of about 10 ppm to about 1000 ppm. More preferably, the concentration of the surfactant is in the range of about 10 ppm to about 200 ppm. The most preferred concentration of the surfactant is about 50 ppm because it is cost effective, viral reduction effective, and safe to consumers. Moreover, Example 1 shows that as the concentration of the surfactants increased, the amount of log virus reduction increased; however, once the concentration of the surfactant was over 50 ppm, the virus reduction level did not significantly increase. While the use of more surfactant led to slightly more reduction in viral titer, the increase was not enough to outweigh the fact that the use of more surfactant would be less cost effective and can potentially cause more health concerns for consumers.

Preferably, in the surfactant-sanitizer combination of the present invention, the concentration of the sanitizer should be less than 200 ppm (especially if the sanitizer is the chlorine solution). However, other sanitizers may have concentrations higher than 200 ppm. Further, more than one sanitizer can be included in the surfactant-sanitizer combination. Similarly, more than one surfactant may also be used in the formulation of the present invention. For example, SDS can be combined with Tween 20, and then the resulting surfactant mixture can be combined with chlorine water (sanitizer) to form the surfactant-sanitizer combination/mixture.

Other than the choice of sanitizer and the concentration used, many factors can influence the efficiency of virus removal, such as washing or contact time between the sanitizer and the food, the type of washing, and the nature of the food to which the virus has attached. In the present invention, the washing time is preferably in the range of about 1 minute to about 15 minutes. In the examples, one washing contact time of 2 minutes and four types of fresh produce were tested. In general, virus removal is enhanced when the washing contact time between the sanitizer and the food is increased. However, for fresh produce, the extended contact time is likely to damage the appearance of the produce. Therefore, the more preferred range of the washing contact time is about 1 minute to about 10 minutes.

The strength of the agitation during the washing time can also change the efficiency of virus removal from food. For example, if the produce is agitated more aggressively than merely agitating gently by hand as shown in the examples, the virus removal efficiency is likely to increase. On the other hand, as with the length of the washing contact time, the more aggressive agitation can damage the appearance of the fresh produce.

Assuming all other factors the same, a different type of foods can have a different efficiency in virus reduction by a sanitizer or sanitizer formulation. Foods such as strawberries and raspberries typically show a higher efficiency in virus reduction by the same sanitizer than that of cabbage and lettuce. This is likely caused by the larger surface areas for the berries to which the virus can attach than that of cabbage and lettuce. The texture of a strawberry is also very different from that of lettuce, which may also have an effect on the strength of a virus' attachment and the ability of removing the virus by a sanitizer. In addition, there are many more structural cavities in leafy greens such as wrinkles, which may provide a shielding effect, increasing the difficulty of removal. Finally, it has been found that bacterial pathogens can become internalized in leafy greens via stomata where CO₂ and O₂ exchange occurs. Recently, evidence has suggested that viral pathogens can also be internalized; however, it is uncertain whether or not the internalization occurs via the stomata. Therefore, it is possible that some viruses can be internalized during the contamination period prior to the sanitization process, shielding from removal by sanitizers. As such, fewer viruses can be removed from leafy greens due to this virus internalization. There is a need for a sanitizer that can remove tightly bound viruses from various fresh produce regardless of whether or not these viruses are located in the structure cavities and/or are internalized.

It is known that surfactants can interact with viral proteins. This interaction can influence protein folding/refolding, denaturation, and aggregation, possibly resulting in virucidal activities. The virucidal activity of surfactants for sexually transmitted viruses has been widely reported. For example, Howett et al., (1999) found that SDS had virucidal activity against papillomaviruses, herpes simplex virus-2 (HSV-2), and human immunodeficiency virus-1 (HIV-1) (Howett et al., Antimicrob. Agents Chemother. 43:314-321, 1999). Urdaneta and co-authors (2005) found that HIV-1 could be inactivated by SDS in breast milk to avoid transfer of viruses to infants when formula feeding is not practicable (Urdaneta et al., Retrovirology 2:28-38, 2005). Moreover, SDS has been used to prevent the transmission of HIV during sexual intercourse (Howett and Kuhl, Cum Pharm. Des. 11:3731-3746, 2005). In addition, Song and others (2008) reported that SDS, NP-40, and Triton X-100 were able to reduce the infectivity of the hepatitis C virus, whereas it has been reported that Triton X-100 was able to partially denature the coat protein of tobacco mosaic virus (TMV) and then induce aggregation of this coat protein (Panyukov et al., Macromol. Biosci. 8: 199-209, 2008).

Nevertheless, the effectiveness of any surfactant on inactivating foodborne viruses is not known, especially from fresh produce. Because viruses differ dramatically from each other, one virucidal agent for one type of viruses might not be effective against another. HIV is an enveloped virus, while foodborne viruses, such as human norovirus, are mostly non-enveloped viruses. As discussed before, the lack of an envelope for foodborne viruses makes them very resistant to agents such as acids, pH, environmental stresses, and disinfectants. The typical washing solution used in the food industry, sodium hypochlorite, usually gives less than 1 log of virus reduction, which falls below the desired effective level of about 3 logs of virus reduction or higher.

It is surprising to find, through Examples 2 and 3, that the common food grade surfactants, such as SDS, can be useful in the inactivation of many viruses, both enveloped and non-enveloped. More specifically, commonly used surfactants, such as SDS, NP40, Triton X-100, and Tween 20, are able to inactivate a human norovirus surrogate, MNV-1, in a dose-dependent manner. SDS appears to be the most effective surfactant against MNV-1, and eliminated virtually all MNV-1 at 10,000 ppm. Incubation of MNV-1 with 200 ppm of SDS solution at 37° C. for 4 hours resulted in a 3 logs virus reduction. VSV, an enveloped virus, is much more sensitive to surfactants than MNV-1 as evidenced by a 5 logs reduction of VSV upon incubation with 200 ppm of SDS at 37° C. for 4 hours. Example 3 shows that the capsid protein of MNV-1 became aggregated after incubation with SDS and the structure of MNV-1 capsid was severely altered. SDS also disrupted the envelope of VSV and distorted the shape of virions. As such, SDS and other surfactants can inactivate viruses, both enveloped and non-enveloped, after they are mixed with viruses directly.

Despite the surfactant's ability to reduce surface tension and its ability to inactivate viruses, it was unexpected that the addition of a very small amount of a surfactant can enhance sanitization of foodborne viruses on fresh produce to about 3 logs of virus reduction or higher without damaging the freshness of the produce. At the concentration of the 50 to 200 ppm of the surfactants (Example 2), after an extended 72 hours of incubation time, approximately 2.0 to 2.5 logs virus reduction was observed for all four surfactants. The sanitization process of the fresh produce at maximum only allows for about 20-30 minutes of washing contact time with the sanitizer solution, and most typically allows only a few minutes of washing contact time. Further, fresh produce, such as raspberries and lettuce, has many factors that prevent virus sanitization or reduction, such as partially exposed surface area, many shielded cavities such as wrinkles and folds, and virus internalization. As such, despite the mere ability to damage or inactivate foodborne viruses after 72 hours of incubation and the ability to reduce surface tension, it is unexpected for the addition of a small amount of a surfactant (about 10 ppm to about 200 ppm, preferably about 50 ppm) to a sanitizer can achieve an effective virus sanitization on fresh produce (about 3 logs of virus reduction or higher) after only a few minutes of gentle agitation.

Such an effective sanitization by the formulation of the present invention was unexpected especially in view of that many existing sanitation materials, such as mild detergents, already use some surfactants in their formula without achieving effective reduction of viruses on the produce (to about 3 logs of virus reduction or higher). Further, many more strong sanitation materials, such as peroxide, are not able to achieve even 2 logs of reduction of pathogens, such as human norovirus surrogate. Surprisingly, the formulation comprising only an additional small amount of surfactant (50 ppm) in water can achieve 3 logs of virus reduction on some fruits, such as strawberries, and can achieve approximately 2 logs of virus reduction on lettuce, cabbage and raspberries (after only 2 minutes of gentle agitation). More surprisingly, the addition of only a small amount of surfactant (50 ppm) to the common sanitizer (the 200 ppm chlorine water) can consistently achieve an effective virus reduction level of about 3 logs or higher for various fresh produce after only 2 minutes of gentle agitation. In sum, the formulation of the present invention can achieve effective virus reduction on fresh produce without damaging them.

The present invention also includes a method of reducing viruses on produce, including adding at least one surfactant to the sanitization process of the produce, in which at least one sanitizer is used. Alternatively, the method of reducing viruses on produce includes adding a formulation of at least one surfactant, at least one sanitizer, and one solvent to the sanitization process of the produce.

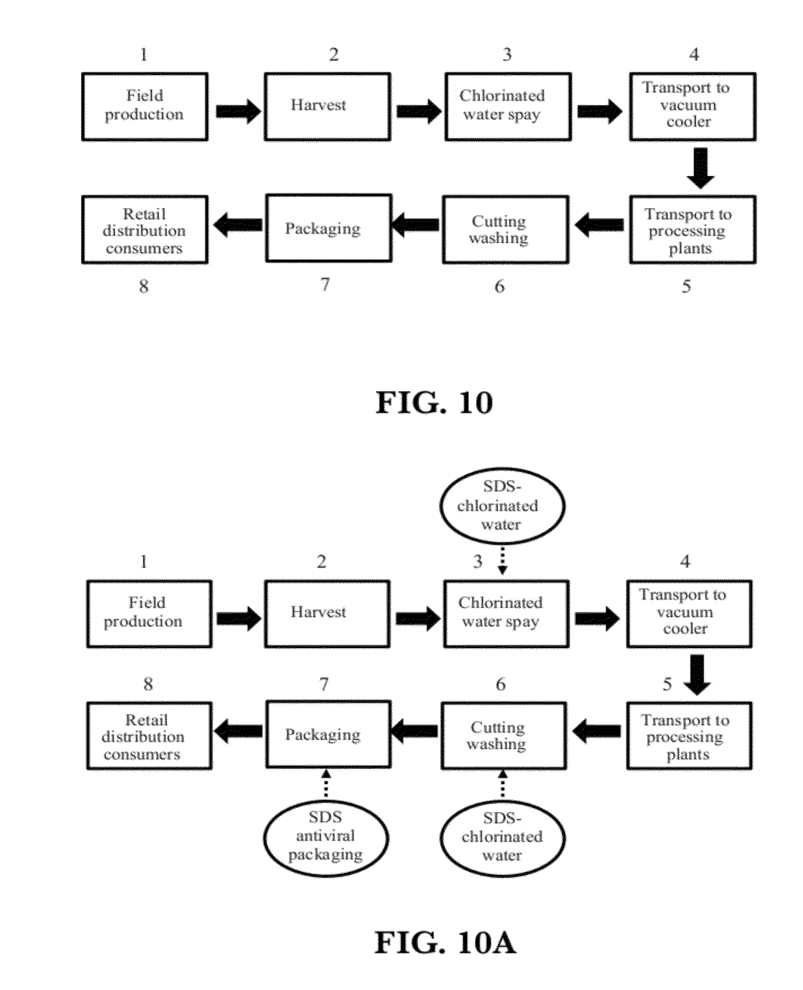

FIG. 10 shows a flow chart of the current practice for processing leafy greens in the fresh produce industry. After the leafy greens are produced in the field in step 1, the leafy greens are harvested from the field in step 2. The leafy greens so harvested are typically subjected to a spray of chlorinated water in step 3 (the first sanitization step). To keep the leafy greens fresh, the produce is then transported for vacuum cooling in step 4. After the cooling step (step 4), the produce continues to be transported (step 5) to processing plants for cutting, washing by chlorinated water (step 6), and packaging (step 7), followed by retail distribution to consumers (step 8).

In the chain of this processing event, FIG. 10a shows that the use of one or more surfactants can be easily applied during the sanitization steps 3 and/or 6, by simply adding about 10 to about 200 ppm of SDS, preferably about 50 ppm. For example, to the chlorine solution already used currently in steps 3 and/or 6, SDS can be added simply and inexpensively. That is, the SDS can be added to the chlorine solution in step 3 before the transportation to the vacuum cooling in step 4, or during cutting and washing of step 6, or both. The addition of surfactant to the sanitization spray solution in step 3 would help with any potential subsequent contamination acquired during the pre-harvesting or harvesting in steps 1 and 2. Of course, if the pre-prepared mixture of surfactant and sanitizer (SDS-chlorine) is applied to the steps 3 and/or 6, the virucidal activities might be even higher as the surfactant might be more evenly distributed among the sanitizer so that each can better enhance the other's virucidal activity.

Another possible way to use the present invention to enhance virus reduction on the produce would be to apply the surfactant-sanitizer formulation of the present invention to the package coating in step 7 before transporting the produce to the retail distribution center. Alternatively, a mere coating of the surfactant can also be applied on the packaging. Of course, the preferred surfactant is SDS while the popular sanitizer is chlorine water. Since it is known that viruses can survive on and/or in foods with high stability for many weeks to months, SDS could inactivate the viruses on the produce during the storage period. However, fresh produce is packaged differently: some are packaged in boxes, while others are packaged in individual plastic wrappers. Therefore, the effectiveness of virus reduction of this method might vary.

All or any of these applications could be implemented in the food industry to further enhance the safety of fresh produce and hopefully reduce the incidence of produce-associated outbreaks of foodborne viruses and/or bacteria.

### EXAMPLES

The examples examine the abilities of the formulations of the present invention to enhance virus removal from fresh produce. The examples are provided to illustrate various embodiments of the invention and are not intended to limit the scope of the invention in any way.

The examples used the following four types of viruses: murine norovirus strain MNV-1, vesicular stomatitis virus (VSV) Indian strain, human rotavirus, and hepatitis A virus. Because human norovirus cannot be propagated in cell culture, its surrogate, murine norovirus, was used because of its stability and genetic relatedness to human norovirus. VSV was used to examine the effectiveness of virus reduction by the formulation of the present invention on the enveloped viruses. The other types of commonly encountered non-enveloped foodborne viruses were also examined: human rotavirus and hepatitis A virus.

### Example 1

Matrials and Methods

Cell Culture and Virus Stock. MNV-1 was propagated in murine macrophage cell line RAW 264.7 (ATCC, Manassas, Va.) as follows: RAW 264.7 cells were cultured and maintained in Dulbecco's Modified Eagle Medium (Invitrogen, Carlsbad, CALIF.) with the addition of 10% fetal bovine serum (Invitrogen) at 37° C. under a 5% CO₂ atmosphere. To prepare MNV-1 stock, confluent RAW 264.7 cells were infected with MNV-1 at a multiplicity of infection (MOI) of 20. After 1 hour of incubation at 37° C., 15 mL DMEM supplemented with 2% fetal bovine serum (FBS) were added. After two days post-infection, the viruses were harvested by freeze-thawing three times, and the supernatant was collected after centrifugation at 5,000 rpm for 20 minutes at 4° C.

Vesicular Stomatitis Virus (VSV) VSV stock was prepared as described. Briefly, confluent BHK-21 cells were infected with VSV at a MOI of 3. After 1 hour incubation at 37° C., 15 ml of DMEM supplemented with 2% FBS were added. Viruses were harvested after 18 hours post inoculation by centrifugation at 5,000 rpm for 10 minutes at 4° C. The virus suspension was stored at −80° C. in aliquots.

MNV-1 and VSV Plaque Assay. MNV-1 plaque assay was performed in the following process. RAW 264.7 cells were seeded in 6 well plates (Corning Life Sciences, Wilkes-Barre, Pa.) at a density of 2×10⁵ cells per well. After 24 hours of incubation, cells were infected with 400 μL from a 10-fold dilution scheme of the viruses. After 1 hour of incubation at 37° C. with agitation every 15 minutes, the cells were overlaid with 2.5 mL of minimal eagle medium (MEM) containing 2% FBS, 1% sodium bicarbonate, 0.1 mg/mL of kanamycin, 0.05 mg/mL of gentamicin, 15 mM HEPES (pH 7.7), 2 mM L-glutamine, and 1% agarose. After incubation at 37° C. for two days, the plates were fixed with 10% formaldehyde, and the plaques were then visualized by staining with crystal violet. VSV plaque assay was performed in the same way except that Vero cells were used in the assays and the plaques were fixed 24 hours post-inoculation.

Inoculation of MNV-1 to Fresh Produce. Fresh produce samples (strawberries, raspberries, cabbage, and romaine lettuce) were purchased from a local supermarket. A sample consisting of 50 g was placed in a sterile plastic bag. MNV-1 stock (5.0×108 PFU/ml) was added to each sample to reach an inoculation level of 3.0×10⁶ PFU/g. The bag was heat-sealed using an AIE-200 Impulse Sealer (American International Electric, Whittier, Calif.), and the samples were mixed thoroughly by shaking at the speed of 200 rpm at room temperature for 1 hour to allow attachment of viruses to the sample.

Sanitization Procedure. SDS (powder), and NP-40, Triton X-100, and Tween 20 (liquid) were purchased from Sigma (St. Louis, Mo.), and chlorine bleach containing 6% sodium hypochloride was purchased from a local supermarket. The MNV-1 inoculated fresh produce was sanitized by tap water, 200 ppm of chlorine solution, surfactant alone, and solutions containing both surfactant and chlorine. For strawberries and raspberries, the amount of washing solution was 2 L. For lettuce and cabbage, 4 L of washing solution were used. Freshly prepared washing solution was used for every replication, and the washing container was cleaned and rinsed out between replications. Each sample was washed by each sanitizer with gentle agitation by hand for 2 minutes. After sanitization, the fresh produce was placed into a stomach bag. The remaining viruses were eluted by addition of 20 mL of PBS solution and stomached for 3 minutes. The viral survivors were determined by plaque assay.

Virucidal Assay. A non-enveloped virus (MNV-1) and an enveloped virus (VSV) were used to test whether surfactants can directly inactivate the viruses. 1 ml of MNV-1 (10⁸ PFU/ml) and VSV (10¹⁰ PFU/ml) stocks were incubated with each surfactant at 37° C. At each time point, 50 μl of the virus sample was collected, and the virus survivors were determined by plaque assay. Because surfactants are known to have cytotoxic effect, the inoculum solutions were removed after 1 hour of incubation before the overlay was added. For VSV inactivation, only one concentration (200 ppm) of each surfactant was used. The virus samples were collected after 1, 4, 8, 12, 24, 36, and 48 hours of incubation. For MNV-1 inactivation, three concentrations (200 ppm, 1,000 ppm, and 10,000 ppm) of each surfactant were used. The time points were 1, 4, 8, 12, 24, 36, 48, 60, and 72 hours. The kinetics of viral inactivation was generated for each surfactant.

Purification of MNV-1. To grow a large stock of MNV-1, 18 confluent T150 flasks of RAW 267.1 cells were infected with MNV-1 at a MOI of 20 in a volume of 3 ml of DMEM. At 1 hour post-absorption, 15 ml of DMEM with 2% FBS was added to the flasks, and infected cells were incubated at 37° C. for 48 hours. When extensive cytopathic effect (CPE) was observed, cell culture fluid was harvested and subjected to three freeze-thaw cycles to release virus particles. The purification of MNV-1 was performed using the following method: Virus suspension was centrifuged at 10,000×g for 15 minutes to remove cellular debris. The supernatant was digested with DNase I (10 μg/ml) and MgCl₂ (5 mM) at room temperature. After 1 hour incubation, 10 mM EDTA and 1% lauryl sarcosine were added to stop nuclease activity. Viruses were concentrated by centrifugation at 82,000×g for 6 hours at 4° C. in a Ty 50.2 rotor (Beckman). The pellet was resuspended in PBS and further purified by centrifugation at 175,000×g for 6 hours at 4° C. through a sucrose gradient (7.5 to 45%) in an SW55 Ti rotor (Beckman). The final virus-containing pellets were resuspended in 100 μl PBS. The virus titer was determined by plaque assay on RAW 264.7 cells. Viral protein was measured by Bradford reagent (Sigma Chemical Co., St. Louis, Mo.).

Purification of VSV. 10 confluent T150 flask BHK-21 cells were infected by VSV at a MOI of 0.01. At 1 hour post-absorption, 15 ml of DMEM (supplemented with 2% FBS) was added to the cultures, and infected cells were incubated at 37° C. After 24 hours post-infection, cell culture fluid was harvested by centrifugation at 3,000×g for 5 minutes. Viruses were concentrated by centrifugation at 40,000×g for 90 minutes at 4° C. in a Ty 50.2 rotor. The pellet was resuspended in NTE buffer (100 mM NaCl, 10 mM Tris, 1 mM EDTA [pH 7.4]) and further purified through 10% sucrose NTE by centrifugation at 150,000×g for 1 hour at 4° C. in an SW50.1 rotor. The final pellet was resuspended in 0.3 ml of NTE buffer. The virus titer was determined by plaque assay on Vero cells, and the protein content was measured by Bradford reagent (Sigma Chemical Co., St. Louis, Mo.).

Transmission Electron Microscopy. Negative staining electron microscopy of purified virions was performed to determine the impact of surfactants on the virus particles, namely, whether surfactants damaged the virus particles. 60 μl of highly purified MNV-1 and VSV suspension was incubated with 1,000 and 200 ppm of SDS at 37° C. for 48 hours, respectively. Viral plaque assay was conducted to confirm the inactivation of viruses. 20 μl aliquots of either treated or untreated samples were fixed in copper grids (Electron Microscopy Sciences, Hatfield, Pa.), and negatively stained with 1% ammonium molybdate. Virus particles were visualized by FEI Tecnai G2 Spirit Transmission Electron Microscope (TEM) at 80 kV at Microscopy and Imaging Facility at the Ohio State University. Images were captured on a MegaView III side-mounted CCD camera (Soft Imaging System, Lakewood, Colo.) and figures were processed using Adobe Photoshop software (Adobe Systems, San Jose, Calif.).

Statistical Analysis. All experiments were done in triplicate. The surviving viruses were expressed as mean log viral titer±standard deviation. Statistical analysis was done using one-way ANOVA, with a value of p<0.05 being statistically significant. The washing efficiency of the various sanitizer solutions was based on the capability to remove viruses from strawberries.

### Results

The Effect of SDS on MNV-1 Virus Removal From Produce

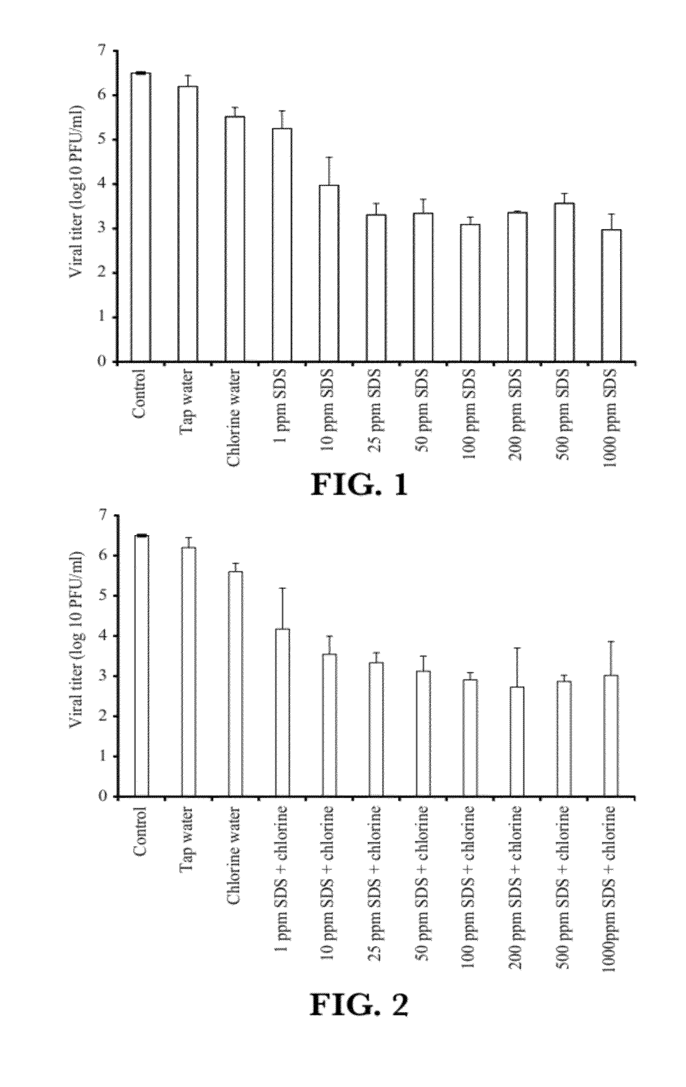

Strawberries: The reduction of MNV-1 on strawberries using either SDS alone (FIG. 1) or a combination of SDS with 200 ppm of a chlorine solution (FIG. 2) was first studied. The MNV-1 contaminated samples of 50 g strawberries were washed with either SDS solution alone (FIG. 1) or a combination of SDS with chlorine solution (FIG. 2) for 2 minutes at room temperature. The amount of the surviving viruses after treatment was quantified by plaque assay. FIG. 1 shows the viral survivals after each treatment of SDS (at various concentrations). The results show that tap water washing only gave a 0.8 log reduction in virus titer. 200 ppm chlorine brought a slight statistically insignificant increase in virus reduction (in comparison to tap water alone). A significant improvement in virus reduction was observed when an SDS solution was used. An increasing concentration of SDS from 1 ppm to 100 ppm gradually increased the virus reduction, and then, further increasing concentration of SDS from 100 ppm to 1000 ppm did not show any further significant increase in virus reduction. A 3.14 logs virus reduction was achieved when 50 ppm SDS solution was used (a statistically significant increase over that of tap water and over that of chlorine solution), and then 100 ppm SDS solution showed a slightly increased virus reduction with 3.41 logs virus reduction. However, the washing efficiency of SDS did not continuously increase after its concentration reached 200 ppm. For example, 1,000 ppm SDS gave a 3.51 logs virus reduction, which was only slightly higher than that of 200 ppm SDS concentration (3.12 logs reduction) (P>0.05). In conclusion, these results in FIG. 1 show that SDS solution alone significantly increased the removal of viruses from strawberries even at a very low concentration of about 20 ppm to about 100 ppm, maybe to 1,000 ppm.

Then, SDS and chlorine solution were combined to evaluate the effectiveness of this combination for reducing viruses on MNV-1 contaminated strawberries. The same washing procedure was used: Strawberries were washed with chlorine solutions containing increasing amounts of SDS ranging from 10 to 1,000 ppm. FIG. 2 shows that SDS enhanced the efficiency of virus removal of the chlorine solution in a dose-dependent manner. When only 10 ppm SDS was added to the chlorine solution, the virus reduction capability increased to 2.94 logs virus reduction from 0.96 log virus reduction (chlorine solution alone). The addition of 50 ppm SDS increased the virus reduction to 3.36 logs. Similar to SDS alone as shown in FIG. 1, the virus reduction capability was not further enhanced by the addition of 200 ppm or higher concentrations of SDS to chlorine solution. Overall, the results show that the virus removal capability of the sanitizer was significantly enhanced by the addition of only 50 ppm SDS to the chlorine solution.

Comparing FIG. 1 to FIG. 2, there is no significant difference in the capabilities of removing viruses from strawberries between the SDS solution alone and the SDS-chlorine combination solution. For example, the combination of 50 ppm of SDS and 200 ppm of chlorine solution led to a virus reduction of 3.36 logs, which was just slightly higher than the virus reduction caused by 50 ppm SDS alone (3.14 logs). Further comparisons of the washing efficiencies between SDS and SDS-chlorine solutions showed that SDS and SDS-chlorine solutions had comparable efficiencies in removing MNV-1 from strawberries (data not shown). As such, the results demonstrate that virus removal from strawberries is significantly improved both by using SDS alone or a combination of SDS and chlorine solution. It also showed that 50 ppm of SDS is an optimal working concentration under this experimental condition because it is cost effective, highly efficient in virus removal, and safe to consumers. More importantly, no other commercial sanitizer is able to achieve a viral reduction of more than 3 logs on fresh produce using the current sanitization process. In fact, SDS solution and the combination of SDS-chlorine solution enhances the efficiency of virus reduction 100-fold over the traditional sanitizers (such as chlorine solution alone) to about 3 logs of virus reduction or higher.

Leafy Greens (Cabbage and Romaine Lettuce) and Raspberries. After SDS demonstrated significantly enhanced viral reduction capabilities for sanitization of fresh strawberries, the sanitization effect of the SDS was explored on other fruits and vegetables. These two leafy greens (cabbage and romaine lettuce) and one other fruit (raspberries) were selected because their surfaces are strikingly different from that of strawberries and because they are often contaminated by noroviruses. The same sanitization procedure was used for cabbage, lettuce and raspberries. The results of the MNV-1 virus removal capabilities of various sanitizers are shown in FIG. 3.

Similar to strawberries, the tap water and 200 ppm chlorine solution only resulted in about 1.23 and 1.48 logs virus reduction for raspberries, respectively. However, 50 ppm SDS alone showed a relatively lower viral reduction for the sanitization of fresh raspberries than that of fresh strawberries: It caused a 2.63 logs virus reduction on raspberries while it resulted in a 3.14 logs virus removal from strawberries. On the other hand, when the 50 ppm SDS was combined with the chlorine solution, a 3.05 logs virus reduction was achieved for the sanitization of raspberries.

Similar to raspberries, the 50 ppm SDS alone showed a lower viral reduction capability for cabbage. In fact, for cabbage, SDS alone exhibited an efficiency of virus reduction similar to that of the chlorine solution. However, the SDS (50 ppm)-chlorine combination solution resulted in a 2.56 logs virus reduction for cabbage.

For lettuce, tap water and chlorine solution only led to 0.23 and 1.12 logs virus reduction respectively. In contrast to cabbage, 50 ppm SDS alone gave a 2.26 logs virus reduction on lettuce, which was significantly higher than that of chlorine solution (P<0.05). The combination of SDS and chlorine further enhanced the virus removal with an up to 2.90 logs of virus reduction.

Therefore, FIGS. 1 to 3 demonstrate that for all four tested fruits and vegetables, the combination of 50 ppm SDS and 200 ppm chlorine solution resulted in the highest virus reduction to about 3 logs, the desired effective sanitation level. However, while SDS solution alone generally improved the virus reduction (sanitization) efficiency compared to that of the chlorine solution, there were notable differences in its virus reduction efficiency among different types of fresh produce. For example, 50 ppm SDS alone was able to efficiently remove viruses from strawberries with a 3.14 logs virus reduction, whereas the corresponding virus reduction of raspberries, cabbage, and lettuce were 2.63, 1.80 and 2.26 logs, respectively.

The Effect of Other Surfactants on MNV-1 Virus Removal From Produce

The commonly used surfactants, NP-40, Triton X-100, and polysorbates

(Tween-20, Tween 80, Tween 65), were examined. Experimental design and sanitization procedures for each surfactant were essentially the same as that with SDS.

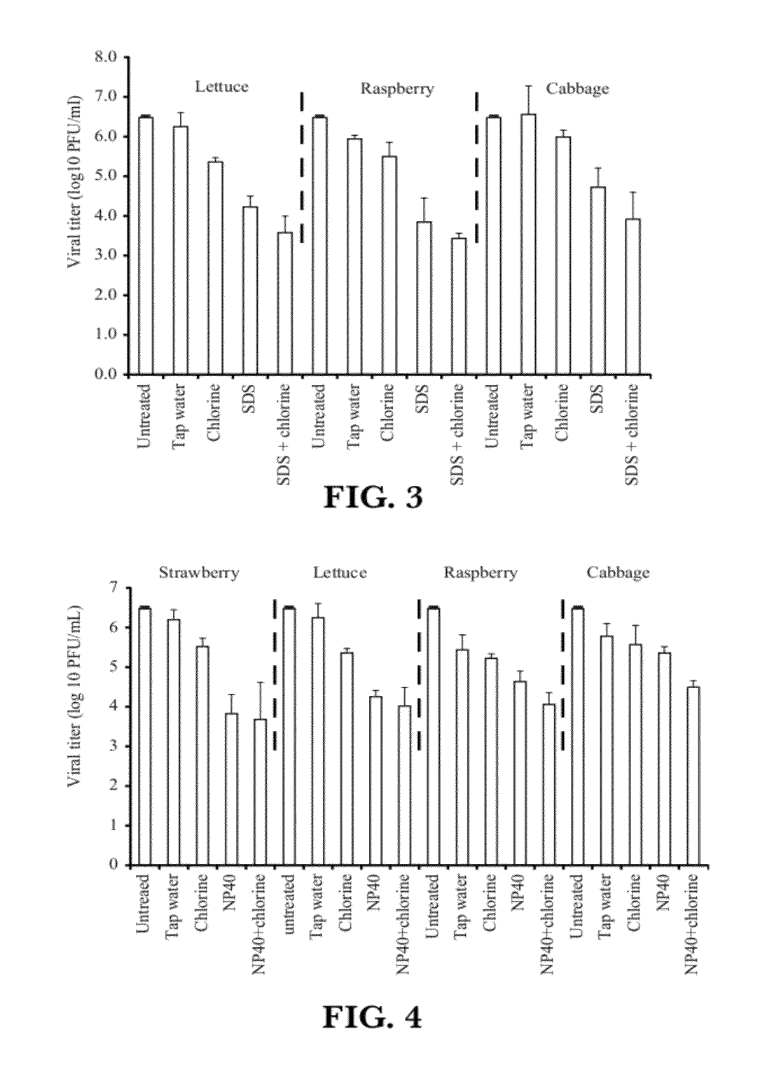

NP-40. FIG. 4 shows that while 50 ppm NP40 alone gave increased virus reduction than did tap water or chlorine solution, the combination of NP40 (50 ppm) and chlorine (200 ppm) demonstrated the highest virus reduction efficiency for all four types of fresh produce: 3. logs virus reduction on raspberries, lettuce, and cabbage; and up to 3.5 logs virus reduction on strawberries.

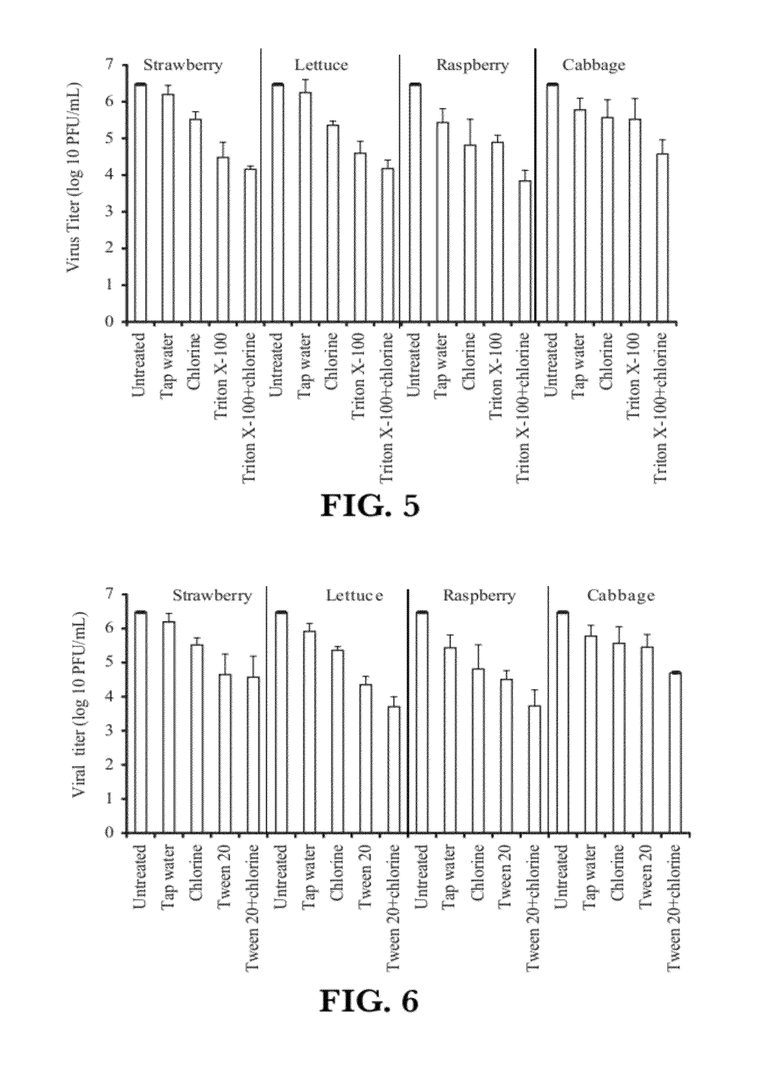

Triton X-100. FIG. 5 shows that the combination of Triton X-100 and chlorine resulted in the highest virus reduction for removing MNV-1 viruses from all four types of fresh produces (approximately 3 logs virus reduction). However, Triton X-100 showed a different efficiency in virus reduction for each different produce: For raspberries and cabbage, Triton X-100 alone (50 ppm) gave similar results as 200 ppm chlorine solution; for strawberries and romaine lettuce, Triton X-100 (50 ppm) caused almost 1 log of additional virus reduction than that of the chlorine solution.

Polysorbates. FIG. 6 shows that similar sanitization results were observed for Tween-20: the combination of Tween-20 and chlorine provided the highest virus reduction efficiency (approximately 3 logs virus reduction). Other polysorbates, such as Tween 80 and Tween 65, were tested. Similar to Tween 20, both Tween 80 and 65 significantly enhanced virus removal (3-3.6 logs virus reduction) from all tested fresh produce (data not shown).

In conclusion, surfactants other than SDS also improve virus removal from fresh produce. More importantly, the combination of a surfactant and chlorine provides an enhanced and effective sanitizer for fresh produce (about 3 logs of virus reduction).

### Example 2

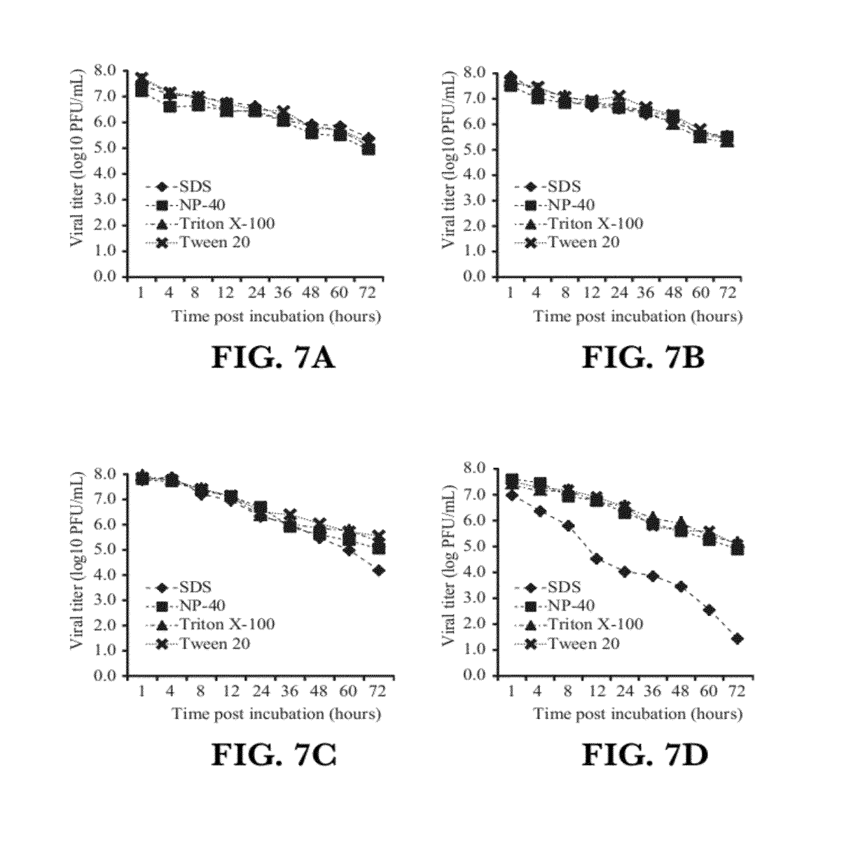

Virucidal activities of surfactants against non-enveloped viruses (MNV-1) and enveloped viruses (VSV) were investigated by adding the surfactants directly to virus stocks—MNV-1 and VSV. The materials and experimental designs were the same as that of Example 1 except the following: Four surfactants were used: SDS, NP-40, Triton X-100, and Tween 20.The MNV-1 stock (10⁸ PFU/ml) was incubated with each surfactant directly at 37° C. During incubation, 50 μl of virus samples were collected after certain time points of incubation up to 72 hours (see FIG. 7), and virus survivors were determined by plaque assay (see Example 1). Four concentrations of each of four surfactants were examined: 50 ppm (FIG. 7A), 200 ppm (FIG. 7B), 1,000 ppm (FIG. 7C), and 10,000 ppm (FIG. 7D).

According to FIG. 7, all four surfactants showed virucidal activities against MNV-1 viruses in the concentration range of 50 ppm to 10,000 ppm: Viral titer gradually reduced when incubation time increased. There was no significant difference in virus reduction among the four surfactants at the concentrations of 50 ppm and 200 ppm (p>0.05) (FIGS. 7A and 7B). At 72 hours of incubation time, approximately 2.0-2.5 logs virus reduction was observed for all four surfactants. At 1,000 ppm, SDS is the most effective virucidal agent among the four surfactants, giving the highest reduction in MNV-1 titer after 72 hours of incubation. Further, virucidal efficiency of SDS dramatically increased when the concentration increased to 10,000 ppm (FIG. 7D). However, for NP40, Triton X-100, and Tween 20, there was no significant increase in virucidal activities at 10,000 ppm when compared to the other three concentrations (50, 200, and 1,000 ppm) (P>0.05). The kinetics of MNV-1 inactivation by Tween 65 and Tween 80 were similar to Tween 20 (data not shown). At 72 hours of incubation time at 10,000 ppm, a 6.1, 2.4, 2.5, and 2.6 logs virus reductions were observed for SDS, NP40, Triton X-100, and Tween 20, respectively.

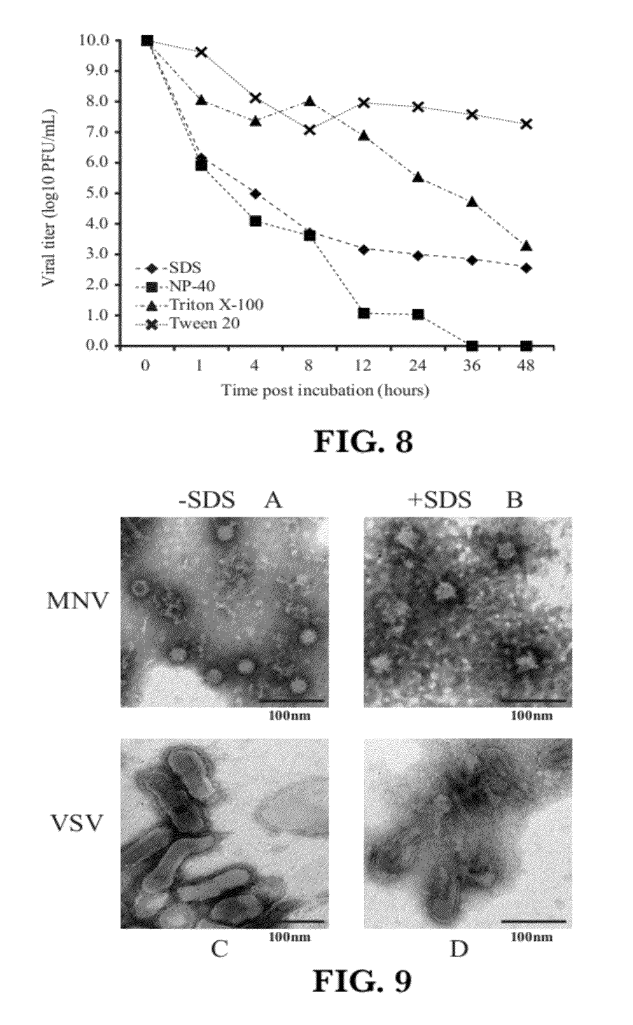

FIG. 8 shows the results of the virucidal activities of four surfactants at 200 ppm against VSV, an enveloped virus. Comparing the results in FIG. 8 and FIG. 7B, VSV was much more sensitive to SDS, NP40 and Triton X-100 than MNV-1. NP40 appears to have the highest virucidal activity against VSV, followed by SDS, Triton X-100, and Tween 20. At 72 hours of incubation, 10., 7.5, 6.7 and 2.7 logs virus reductions were observed with NP40, SDS, Triton X-100, and Tween 20, respectively. The kinetics of VSV inactivation by Tween 65 and Tween 80 was similar to that by Tween 20 (data not shown). In conclusion, FIGS. 7 and 8 demonstrate that the enveloped virus (VSV) is much more sensitive to all surfactants than that of the non-enveloped virus (MNV-1). With regards to both viruses, SDS is more effective in inactivating both MNV-1 and VSV together when compared to other tested surfactants. For example, 10,000 ppm SDS almost completely inactivated MNV-1 after 72 hours of incubation. For VSV, 200 ppm SDS gave 7.5 logs virus reduction after 72 hours of incubation.

### Example 3

The virus inactivation by the surfactants was further examined. The materials and process were the same as in Example 1 except: SDS was added to a purified virus stock (MNV-1 or VSV) to a final concentration of 10,000 ppm, allowed to incubate at 37° C. for 72 hours, and then the virus samples were fixed in cooper grids, and negatively stained with 1% ammonium molybdate. Plaque assay confirmed that viruses were completely inactivated under this condition. The virus particles were visualized by transmission electron microscopy. FIG. 9 shows both MNV-1 and VSV with and without SDS: untreated MNV-1 (FIG. 9A); MNV-1 treated by SDS (FIG. 9B); untreated VSV (FIG. 9C); and VSV treated by SDS (FIG. 9D).

Typically, undamaged VSV is a bullet-shaped virus of about 70 nm in diameter and about 140 nm in length, with visible spikes anchored in the viral envelope. After the treatment with SDS, FIG. 9 shows that the viral envelope was damaged and the shape of VSV was severely distorted. Furthermore, some virions were completely disrupted and genetic materials were spilled out from the particles.

In contrast, MNV is typically a small round-structured virus of about 30-38 nm in diameter. After incubation with SDS for about 72 hours, FIG. 9 showed that the outer capsid of the MNV-1 was severely damaged and aggregated. The shape of MNV-1 was also altered so that it was no longer completely circular. The virions appeared smaller than 30 nm after treatment with SDS. The results indicate that SDS is able to cause significant damage to viral structures of both enveloped and non-enveloped viruses. Similar observations were obtained for other surfactants, NP40, Triton X-100, Tween 20, Tween 65 and Tween 80 (data not shown).

### Example 4

This example explored the virus removal capability of SDS with sanitizers other than the chlorine solution. The sanitizer included levulinic acid, acetic acid, peracetic acid, quaternary ammonium compounds (QAC), and hydrogen peroxide. The fresh produce used were lettuce, strawberries, and spinach. The virus used was murine norovirus (MNV-1), a human norovirus surrogate.

The material and procedures used were the same as that of Example 1. Briefly, murine norovirus (MNV-1) contaminated samples (50 g of lettuce, strawberries, or spinach) were washed with either a sanitizer or a combination of SDS with 50 ppm of each sanitizer solution for 2 minutes at room temperature. The amount of surviving viruses after treatment was quantified by plaque assay.

Lettuce. FIG. 11 shows the viral survivors after each treatment. Tap water washing only gave a 0.5-log reduction in virus titer. 50 ppm of each sanitizer alone (chlorine, levulinic acid, acetic acid, peracetic acid, quaternary ammonium compounds, and hydrogen peroxide) only brought about 0.5-0.8-log in virus reduction. Remarkably, more than 3 logs virus reduction was achieved when 50 ppm of SDS was combined with each sanitizer. These data demonstrate that a combination of SDS with sanitizer significantly increases the removal of MNV-1 from lettuce.

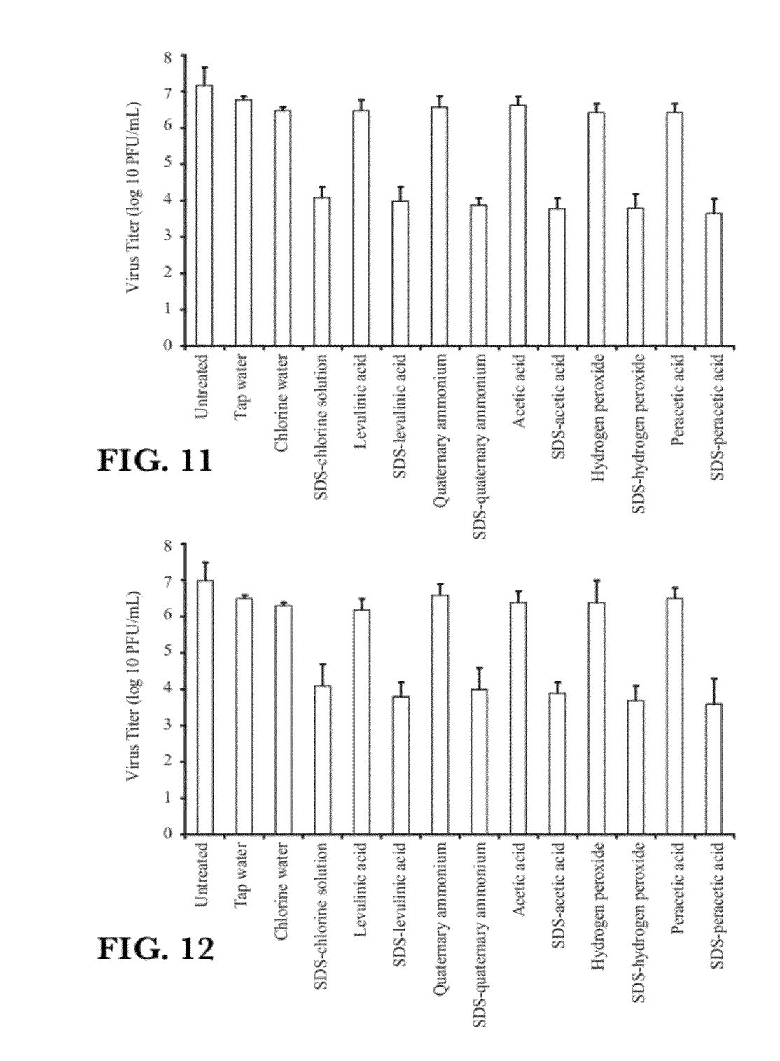

Strawberries. Similarly, as shown by FIG. 12, 50 ppm of each sanitizer alone (chlorine, levulinic acid, acetic acid, peracetic acid, quaternary ammonium compounds, and hydrogen peroxide) was not effective in removing MNV-1 from strawberries, achieving less than 1 log virus reduction. More than 3 logs virus reduction was achieved when 50 ppm of SDS was combined with each sanitizer. These data in FIG. 12 demonstrate that a combination of SDS with sanitizer significantly increases the removal of MNV-1 from strawberries.

Spinach. FIG. 13 shows that each sanitizer alone is not effective in removing MNV-1 from spinach. However, the combination of SDS and sanitizer achieved more than 3 logs virus reduction. The data demonstrate that the SDS-sanitizer combinations all significantly enhance the virus (MNV-1) reduction or removal from spinach.

### Example 5

This example explored the capability of the SDS-sanitizer combination in removing human rotaviruses from fresh produce, such as lettuce, strawberries, and spinach. The sanitizer included levulinic acid, acetic acid, peracetic acid, quaternary ammonium compounds (QAC), and hydrogen peroxide. Human rotavirus Wa strain was used, obtained ATCC (Manassas, Va.). Rotavirus is a non-enveloped virus, the most common cause of severe diarrhea among infants and young children, and is one of several viruses that cause infections often called stomach flu, despite having no relation to influenza. It is a genus of double-stranded RNA virus in the family Reoviridae.

The materials and procedures used were the same as that of Example 1. Briefly, human rotavirus Wa strain contaminated samples (50 g of lettuce, strawberries, or spinach) were washed with either a sanitizer or a combination of SDS with 50 ppm of each sanitizer solution for 2 minutes at room temperature. The amount of surviving viruses after treatment was quantified by plaque assay.

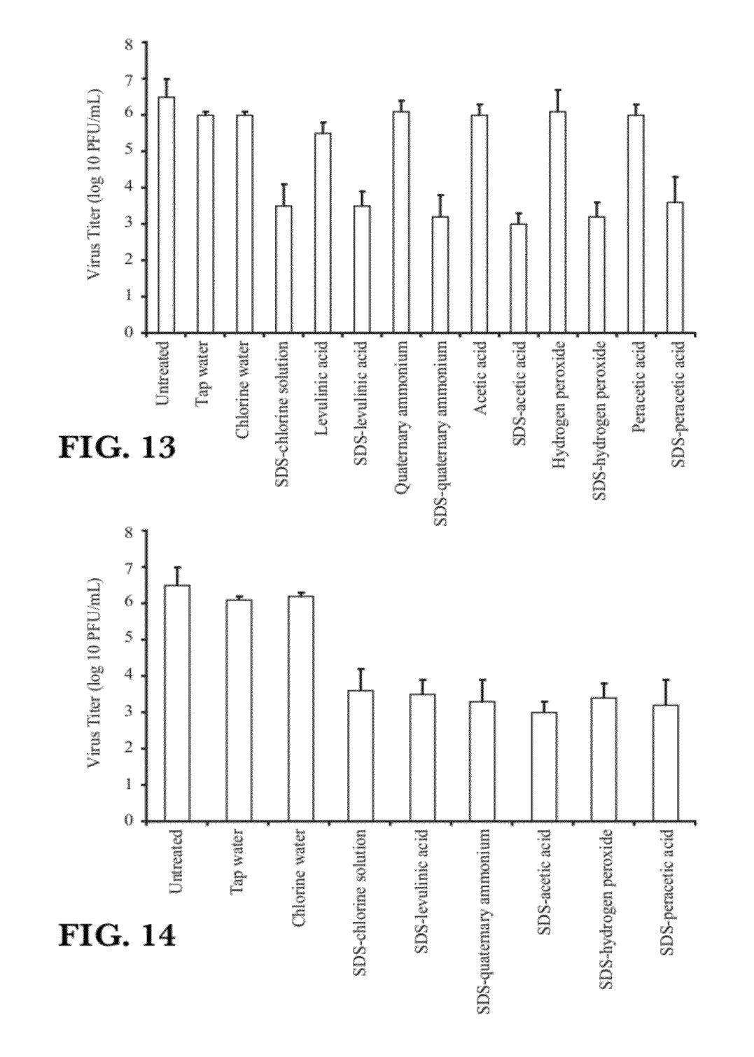

Lettuce: FIG. 14 shows that tap water and chlorine washing gave less than 0.5-log reduction in virus titer. In contrast, a combination of 50 ppm of SDS and each sanitizer (chlorine, levulinic acid, acetic acid, peracetic acid, quaternary ammonium compounds, and hydrogen peroxide) can achieve more than 3 logs rotavirus reduction on lettuce.

Strawberries: FIG. 15 shows that more than 3 logs rotavirus reduction was achieved when 50 ppm of SDS was combined with each sanitizer. However, similar to the results associated with lettuce, tap water and chlorine washing gave less than 0.8-log reduction in virus titer.

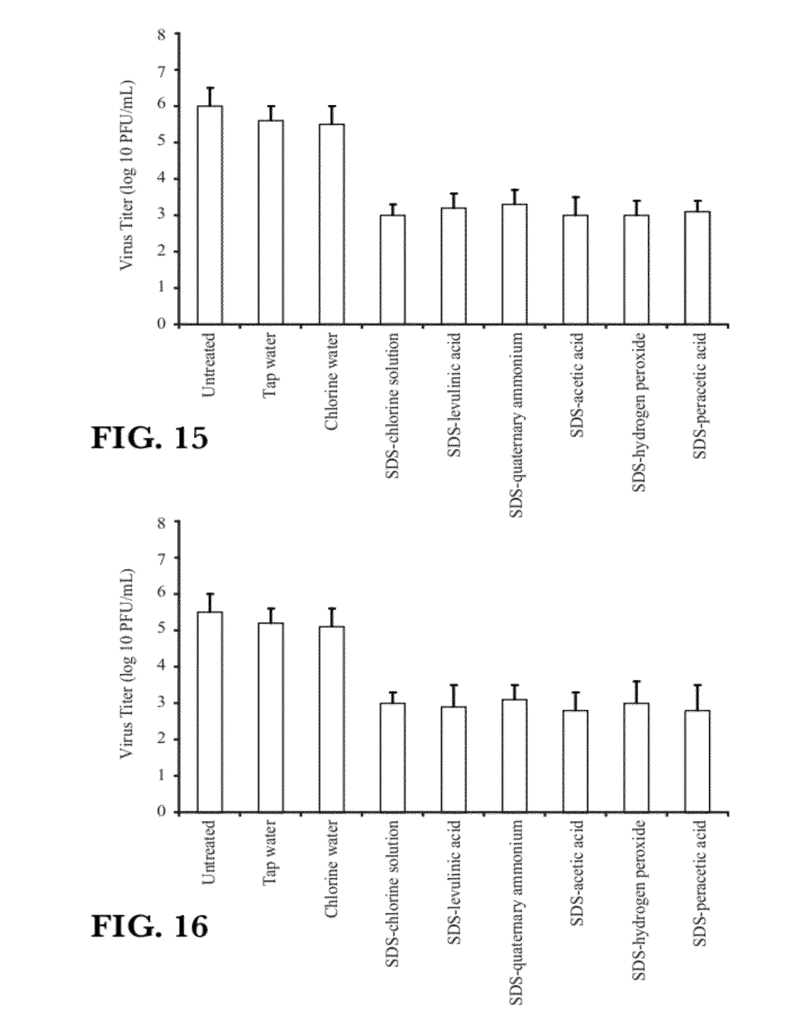

Spinach: FIG. 16 shows enhanced removal of a human rotavirus from spinach by a combination of SDS with a sanitizer, achieving more than 3 logs of rotavirus reduction on spinach. On the other hand, tap water and chlorine washing gave less than 0.8-log reduction in virus titer.

### Example 6

This example examined the capability of the SDS-sanitizer combination in removing hepatitis A viruses from fresh produce, such as lettuce, strawberries, and spinach. The sanitizer included levulinic acid, acetic acid, peracetic acid, quaternary ammonium compounds (QAC), and hydrogen peroxide. Hepatitis A virus HM-175 strain was used, which was obtained from ATCC (Manassas, Va.).

The material and procedures used were the same as that of Example 1. Briefly, Hepatitis A virus contaminated samples (50 g of lettuce, strawberries, or spinach) were washed with either a sanitizer or a combination of SDS with 50 ppm of each sanitizer solution for 2 minutes at room temperature. The amount of surviving viruses after treatment was quantified by plaque assay.

Lettuce: FIG. 17 shows that tap water and chlorine washing gave less than 0.8-log reduction in virus titer. In contrast, a combination of 50 ppm of SDS and each sanitizer (chlorine, levulinic acid, acetic acid, peracetic acid, quaternary ammonium compounds, and hydrogen peroxide) can achieve more than 3 logs hepatitis A virus reduction on lettuce.

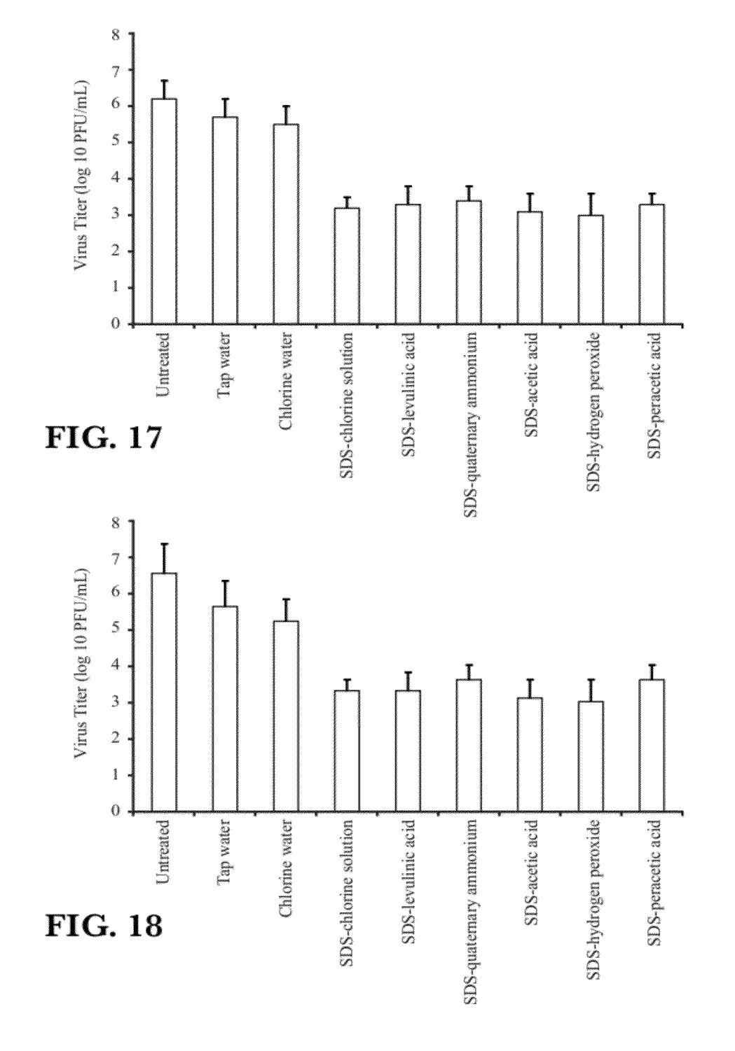

Strawberries: FIG. 18 shows that more than 3 logs hepatitis A virus reduction was achieved when 50 ppm of SDS was combined with each sanitizer. However, similar to the results associated with lettuce, tap water and chlorine washing only gave less than 0.8-log reduction in virus titer.

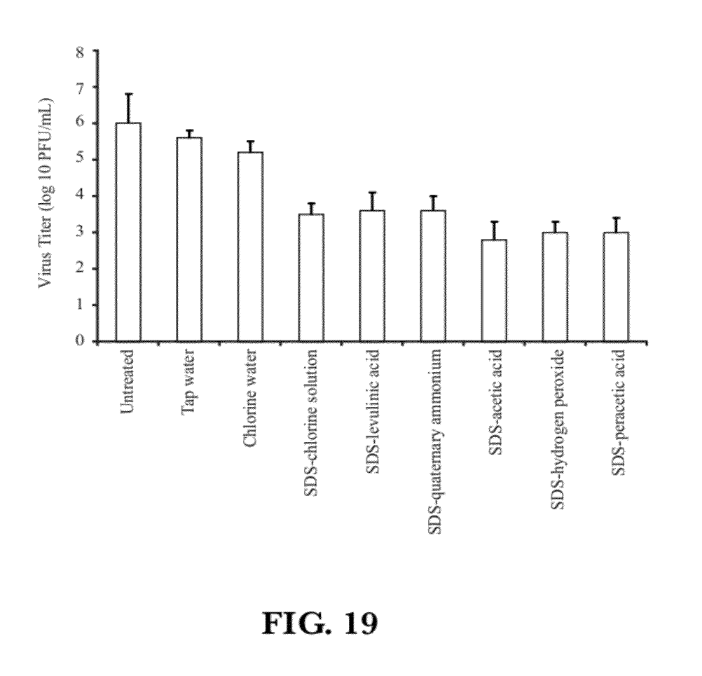

Spinach: FIG. 19 shows enhanced removal of hepatitis A viruses from spinach by a combination of SDS with a sanitizer, achieving more than 3 logs of hepatitis A virus reduction on spinach. On the other hand, tap water and chlorine washing only gave less than 0.8-log reduction in virus titer.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A formulation for removing foodborne viruses from fresh produce, comprising
a) at least one suitable surfactant,
b) at least one sanitizer, and
b) a suitable solvent.

2. The formulation in accordance with claim 1, wherein the surfactant comprises anionic surfactants, non-ionic surfactants, cationic surfactants, zwitterionic surfactants, and mixtures thereof.

3. The formulation in accordance with claim 1, wherein the concentration of the surfactant is in the range of about 10 ppm to about 200 ppm.

4. The formulation in accordance with claim 1, wherein the sanitizer is selected from a group comprising chlorine, hydrogen peroxide, quaternary ammonium compounds, organic acids, organic salts, organic bases, and a mixture thereof.

5. A formulation for removing foodborne viruses from fresh produce, comprising
a) at least one surfactant, and
b) a suitable solvent.

6. A formulation for removing foodborne viruses from fresh produce, comprising
a) at least one surfactant,
b) at least one sanitizer,
c) a suitable solvent, and
d) at least one fresh produce.

7. A method for removing viruses from fresh produce, comprising:
a) adding at least one surfactant to the sanitizing process of the produce, wherein at least one sanitizer is used.

8. A method for removing viruses from fresh produce, comprising:
a) adding the formulation of claim 1 to the sanitizing process of the produce.
